(19) United States
(12) Patent Application Publication
(10) Pub. No.: US 2025/0084206 A1
(43) Pub. Date: Mar. 13, 2025

(54) HARDENER FOR EPOXY RESINS

(71) Applicant: SIKA TECHNOLOGY AG, Baar (CH)

(72) Inventors: Edis KASEMI, Zürich (CH); Urs BURCKHARDT, Zürich (CH); Andreas KRAMER, Zürich (CH); Ursula STADELMANN, Zürich (CH)

(73) Assignee: SIKA TECHNOLOGY AG, Baar (CH)

(21) Appl. No.: 18/563,976

(22) PCT Filed: Jul. 4, 2022
(86) PCT No.: PCT/EP2022/068436

§ 371 Date: Nov. 24, 2023

(30) Foreign Application Priority Data
Jul. 12, 2021 (EP) 21185056.5

(51) Int. Cl. C08G 59/50; C08G 59/18; C08G 59/24

(52) U.S. Cl. CPC C08G 59/5033; C08G 59/184; C08G 59/245; C08G 59/5026

(57) ABSTRACT

The use of an amine of formula (I) for curing epoxy resins, whereby synthetic resin products with a surprisingly high glass transition temperature are formed with particularly low exotherm. The amine of formula (I) enables in particular epoxy resin mouldings, potting compounds and composites which are simple and void for defects to be produced, having beautiful surfaces and allow high service temperatures.

### TECHNICAL FIELD

The invention relates to amines and to the use thereof as curing agents for epoxy resins, and to epoxy resin compositions and uses thereof, especially as shaped body or matrix resin for composite materials.

### PRIOR ART

Curing agents used for epoxy resins are usually primary diamines. However, the selection of inexpensive, commercially available primary diamines is very limited. Particularly frequently used in practice are 1,3-bis(aminomethyl)benzene (meta-xylylenediamine or MXDA) and 1-amino-3-aminomethyl-3,5,5-trimethylcyclohexane (isophoronediamine or IPDA). Both amines are notable for low viscosity and a good thinning effect on epoxy resins, and crosslink these to give chemically stable polymers of high mechanical quality. However, there are only a few manufacturers for these amines, since the preparation process is demanding and entails high capital costs for plants and safety measures. This leads to recurrent supply shortages and fluctuations in price. Moreover, both amines also have technical disadvantages. MXDA is very reactive, and the exothermicity released on curing with the epoxy resin is very high, which can lead to blisters, discoloration or other inhomogeneities in the case of high-build coatings as a result of the high heat input. Moreover, only moderate glass transition temperatures are attained with MXDA, which is a disadvantage especially in the case of adhesives and matrix resins for composite materials. IPDA is superior to MXDA in relation to evolution of heat on curing and glass transition temperature. However, even lower evolution of heat on curing and a broader selection of available primary diamines having advantageous properties in relation to curing and glass transition temperature would be desirable.

US 2014/107313 and US 2015/344406 disclose the use of N,N′-dialkylated MXDA, and EP 3,344,677 the use of N-benzylated ethane-1,2-diamine, as curing agent for epoxy resins. In the case of these amines, some of the functionality is lost as a result of the secondary amino groups, which leads to low glass transition temperatures after curing.

US 2017/226278 and EP 3,344,678 disclose polyamines from the reductive alkylation of dialdehydes such as terephthalaldehyde with propane-1,2-diamine or ethane-1,2-diamine, which contain two primary and two secondary amino groups. They are of comparatively high viscosity, are far less good as thinners of epoxy resins than MXDA or IPDA, and likewise do not enable high glass transition temperatures.

WO 2019/230692 discloses xylylenediamines that have been ethylated at the a positions to the amine groups and have three or four ethyl groups. Because of the high steric hindrance, these amines show greatly reduced reactivity toward epoxy resins, which leads to very slow curing. Moreover, they are highly viscous and very complex to prepare, and the thus cured polymers are less stable to heat and UV light because of the tertiary carbon atom in the curing agent.

### SUMMARY OF THE INVENTION

It is therefore an object of the present invention to provide a primary amine for curing of epoxy resins, which is preparable in a simple manner and enables reliable curing at low exothermicity and a high glass transition temperature. Surprisingly, this object is achieved by an amine of the formula (I) as described in claim 1. The amine of the formula (I) is preparable from readily available starting materials in a simple process. It is of low viscosity and is a good thinner for epoxy resins. It shows a long pot life with epoxy resins and trouble-free curing with surprisingly low exothermicity. This enables use in high-build epoxy resin products such as shaped bodies, potting compounds or matrix resins for composites, without occurrence of blisters, discoloration or other inhomogeneities owing to high evolution of heat. Surprisingly, the amines of the formula (I) attain very high glass transition temperatures, especially with the 1,4 amines and the amines with R=methyl. Moreover, the amine of the formula (I) has surprisingly low odor, which is an advantage in handling and application and is greatly valued by users, and enables cured epoxy resin compositions with particularly low yellowing, which is particularly surprising in the case of A=phenylene.

The amine of the formula (I) especially enables epoxy resin shaped bodies, potting compounds and composites that are producible easily and in a faultless manner, have nice surfaces and enable high use temperatures.

Further aspects of the invention are the subject of further independent claims. Particularly preferred embodiments of the invention are the subject of the dependent claims.

### WAYS OF EXECUTING THE INVENTION

The invention provides for the use of an amine of the formula (I) for curing of epoxy resins,

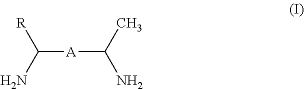

where
R is H or methyl, and
A is a phenylene or cyclohexylene radical.

Substance names beginning with “poly”, such as polyamine or polyepoxide, refer to substances that formally contain two or more of the functional groups that occur in their name per molecule.

A “primary amino group” refers to an amino group that is attached to a single organic radical and bears two hydrogen atoms; a “secondary amino group” refers to an amino group that is attached to two organic radicals that may also together be part of a ring and bears one hydrogen atom; and a “tertiary amino group” refers to an amino group that is attached to three organic radicals, two or three of which may also be part of one or more rings, and does not bear any hydrogen atom.

“Amine hydrogen” refers to the hydrogen atoms of primary and secondary amine groups.

“Amine hydrogen equivalent weight” refers to the mass of an amine or an amine-containing composition that contains one molar equivalent of amine hydrogen. It is expressed in units of “g/eq”.

The “epoxide equivalent weight” refers to the mass of an epoxy group-containing compound or composition that contains one molar equivalent of epoxy groups. It is expressed in units of “g/eq”.

A “thinner” refers to a substance that is soluble in an epoxy resin and lowers its viscosity, and that is not chemically incorporated into the epoxy resin polymer during the curing process.

“Molecular weight” refers to the molar mass (in grams per mole) of a molecule.

“Average molecular weight” refers to the number-average molecular weight Mₙ of a polydisperse mixture of oligomeric or polymeric molecules, which is typically determined by gel-permeation chromatography (GPC) against polystyrene as standard.

“Pot life” refers to the maximum period of time from the mixing of the components and the application of an epoxy resin composition in which the mixed composition is in a sufficiently free-flowing state and has good ability to wet the substrate surfaces.

The “gel time” refers to the time interval from mixing the components of an epoxy resin composition until the gelation thereof.

“Room temperature” refers to a temperature of 23° C.

All industry standards and norms mentioned in the document refer to the versions valid at the date of first filing, unless stated otherwise.

Percent by weight (% by weight) values refer to the proportions by mass of a constituent in a composition based on the overall composition, unless stated otherwise. The terms “mass” and “weight” are used synonymously in the present document.

Preferably, A is selected from the group consisting of 1,3-phenylene, 1,4-phenylene, 1,3-cyclohexylene and 1,4-cyclohexylene.

More preferably, A is 1,3-phenylene or 1,4-phenylene. Such an amine of the formula (I) is particularly compatible with aromatic epoxy resins and enables particularly nice surfaces after curing.

In particular, A is 1,4-phenylene. Such an amine of the formula (I) enables a particularly high glass transition temperature.

The amine of the formula (I) is preferably selected from the group consisting of 1,4-bis(α-aminoethyl)benzene, 1,3-bis(α-aminoethyl)benzene, 1-α-aminoethyl-4-aminomethylbenzene and 1-α-aminoethyl-3-aminomethylbenzene.

Particular preference is given to 1,4-bis(α-aminoethyl)benzene or 1,3-bis(α-aminoethyl)benzene. These amines of the formula (I) enable a particularly high glass transition temperature.

Most preferred is 1,4-bis(α-aminoethyl)benzene. It enables the highest glass transition temperatures and particularly low yellowing.

1-α-Aminoethyl-4-aminomethylbenzene and 1-α-aminoethyl-3-aminomethylbenzene enable particularly rapid curing.

The amine of the formula (I) is preferably a constituent of a reaction product obtained from the reaction of
at least one ketone of the formula (II) with
ammonia or hydroxylamine or an oxime of the formula (III) and subsequent hydrogenation,

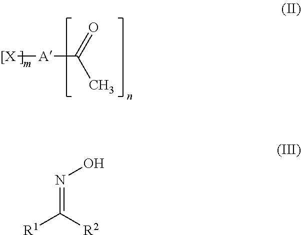

where
m is 0 or 1, n is 1 or 2 and (m+n) is 2,
X is formyl or nitrile,
A′ is a phenylene or cyclohexylene radical, and
R¹ is H or methyl and R² is H or an alkyl radical having 1 to 4 carbon atoms.

Preferably, A′ is a phenylene radical, especially 1,3-phenylene or 1,4-phenylene.

Preferably, R¹ is methyl.

Preferably, R² is an alkyl radical having 1 to 4 carbon atoms, especially methyl or ethyl or isobutyl.

A preferred ketone of the formula (II) is 1,3-diacetylbenzene, 1,4-diacetylbenzene, 4-acetylbenzonitrile, 3-acetylbenzonitrile, 4-formylbenzonitrile or 3-formylbenzonitrile.

Particular preference is given to 1,3-diacetylbenzene or 1,4-diacetylbenzene.

For the reaction, the ketone of the formula (II) is preferably dissolved in an organic solvent. Preferred organic solvents are alcohols, especially methanol, ethanol or isopropanol.

Preference is given to using ammonia or hydroxylamine or an oxime of the formula (III) roughly stoichiometrically or in a stoichiometric excess over the carbonyl groups of the ketone of the formula (II).

For ketones of the formula (II) that are free of nitrile groups, preference is given to using ammonia or hydroxylamine for the reaction. This reaction proceeds with release of water. The reaction is optionally conducted in the presence of a catalyst, for example of a weak base such as potassium carbonate.

For ketones of the formula (II) that contain a nitrile group, preference is given to using an oxime of the formula (III) for the reaction.

A preferred oxime of the formula (III) is acetaldehyde oxime, acetone oxime, methyl ethyl ketoxime, methyl isopropyl ketoxime or methyl isobutyl ketoxime, especially acetone oxime, methyl ethyl ketoxime or methyl isobutyl ketoxime.

With an oxime of the formula (III), the reaction is effected in a transoximation to release the aldehyde or ketone of the formula

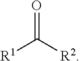

It is preferably effected in the presence of a strong acid, especially perchloric acid.

The reaction proceeds via an intermediate of the formula (IVa), (IVb), (IVc) or (IVd):

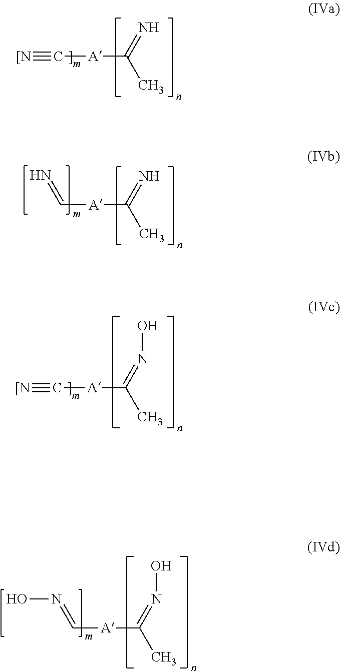

where A′, m and n have the definitions already given.

Prior to the hydrogenation, the intermediate can be isolated and optionally purified, especially by removing the volatile components by distillation or stripping, optionally followed by washing with water or aqueous salt solutions, in order to remove potassium carbonate or perchloric acid for example, or the reaction and hydrogenation are effected in a one-pot process without isolating the intermediate.

The hydrogenation can be effected directly with molecular hydrogen, or indirectly by hydrogen or hydride transfer from other reagents, for example formic acid or LiAlH₄. The hydrogenation is preferably effected with molecular hydrogen. The hydrogenation is preferably conducted in the presence of a suitable catalyst. Preferred catalysts are palladium on charcoal (Pd/C), platinum on charcoal (Pt/C), Adams' catalyst or Raney nickel, especially palladium on charcoal or Raney nickel. When molecular hydrogen is used, the hydrogenation is preferably run in a pressure apparatus at a hydrogen pressure of 5 to 300 bar. This can be effected in a batchwise process or preferably in a continuous process.

The hydrogenation is preferably conducted at a temperature in the range from 40 to 150° C. If A′ is phenylene, the hydrogenation conditions can be chosen such that the phenylene radical is not hydrogenated or is likewise hydrogenated. If a phenylene radical present is not to be hydrogenated in the hydrogenation, preference is given to working at a temperature in the range from 60 to 120° C. and a hydrogen pressure in the range from 10 to 120 bar. Otherwise, preference is given to working at a temperature in the range from 80 to 150° C. and a hydrogen pressure in the range from 150 to 250 bar.

The volatile components, especially any solvent present and any water, are preferably removed from the reaction product after the hydrogenation, especially by distillation or stripping.

The reaction product can be purified further, especially by distillation. This affords a reaction product having a particularly high content of amine of the formula (I).

The invention further provides a reaction product containing at least one amine of the formula (I) obtained from the reaction of
at least one ketone of the formula (II) with
ammonia or hydroxylamine or an oxime of the formula (III) and subsequent hydrogenation, as described above.

The ketone of the formula (II) is preferably 1,3-diacetylbenzene or 1,4-diacetylbenzene. In these, m is 0 and n is 2 in formula (II).

The reaction product preferably contains a content of the amine of the formula (I) of at least 50% by weight, more preferably at least 80% by weight, especially at least 90% by weight, based on the reaction product.

The amine of the formula (I) may take the form of a mixture of an amine of the formula (I) in which A is a phenylene radical, and amine of the formula (I) in which A is a cyclohexylene radical, especially resulting from a partial hydrogenation of a phenylene radical from the ketone of the formula (I).

If the ketone of the formula (II) used was a technical-grade quality of 1,3-diacetylbenzene containing fractions of 1,3,5-triacetylbenzene, the reaction product will contain 1,3,5-tris(α-aminoethyl)benzene in particular as a byproduct.

The amine of formula (I), especially in the form of the reaction product described, is used for curing of epoxy resins.

Suitable epoxy resins are especially glycidyl ethers of commercial mono- or polyfunctional alcohols or phenols, especially the epoxy resins specified in this document.

Preference is given to mixing the amine of the formula (I), the epoxy resin and any further substances with one another, where the ratio of the groups reactive toward the epoxy groups, especially the amine hydrogens of the amine of the formula (I), and the epoxy groups is preferably in the range from 0.5 to 1.5, especially 0.7 to 1.2.

The curing can be effected at ambient temperature, especially in the range from 5 to 40° C., or it can be effected at elevated temperature. It is preferably effected at elevated temperature, especially in the range from 40 to 150° C., preferably 50 to 120° C.

For curing at elevated temperature, the amine of the formula (I) and/or the epoxy resin can be heated individually before being mixed, and/or the mixed composition is heated as it is.

In the case of curing at elevated temperature, the viscosity of the mixed composition is lowered and the curing proceeds particularly rapidly. But the exothermicity released is also particularly critical since this can lead very quickly to significant heating of the curing composition and cause blisters, discoloration and other inhomogeneities.

The amine of the formula (I) gives rise to particularly low exothermicity coupled with reliable, rapid curing. Moreover, the cured material has a very high glass transition temperature, which enables high use temperatures.

The invention further provides an amine-functional adduct formed from the reaction of the amine of the formula (I) and at least one epoxy resin or monoepoxide.

The epoxy resin or monoepoxide preferably has an average epoxy equivalent weight in the range from 150 to 500 g/eq, preferably 156 to 250 g/eq.

Particular preference is given to aromatic epoxy resins, especially aromatic diepoxides such as, in particular, bisphenol A, F or A/F diglycidyl ether or novolak epoxy resins, especially phenol-formaldehyde novolak glycidyl ether. Such adducts enable particularly rapid curing and high glass transition temperatures.

Also preferred are epoxy resins having polyoxypropylene and/or polyoxyethylene units. These are especially diglycidyl ethers of polypropylene glycols or reaction products of bisphenol A, F or A/F diglycidyl ethers with polypropylene glycols or polyethylene glycols. Such adducts are particularly suitable as a constituent of water-based curing agents for epoxy resins.

Also preferred are aromatic monoepoxides, especially cresyl glycidyl ether, tert-butylphenyl glycidyl ether or cardanol glycidyl ether.

Preference is given to adducts from the reaction of the amine of the formula (I) and at least one diepoxide in a stoichiometric ratio in the range from 1 to 10, preferably 1.2 to 5, especially 1.4 to 3, mol of amine of the formula (I) per molar equivalent of epoxy groups.

The invention further provides a curing agent for epoxy resins comprising at least one amine of the formula (I) and/or at least one amine-functional adduct from the reaction of the amine of the formula (I) and at least one epoxy resin or monoepoxide, and at least one further constituent selected from further amines A1, accelerators, thinners, stabilizers and surface-active additives.

The further amine A1 is preferably not an amine of the formula (I).

The curing agent contains preferably 2% to 99% by weight, preferably 5% to 90% by weight, especially 10% to 80% by weight, of amine of the formula (I) and/or amine-functional adduct from the reaction of the amine of the formula (I) and at least one epoxy resin or monoepoxide.

The curing agent is preferably not water-based. It preferably contains less than 15% by weight, especially less than 10% by weight, of water. Such a curing agent is suitable for nonaqueous epoxy resin products.

Suitable further amines A1 are especially amines having at least two, preferably at least three, amine hydrogens that do not conform to the formula (I).

Preferred further amines A1 are polyamines having at least three aliphatic amine hydrogens, especially N-benzylethane-1,2-diamine, N-benzylpropane-1,2-diamine, N-benzyl-1,3-bis(aminomethyl)benzene, N-(2-phenylethyl)-1,3-bis(aminomethyl)benzene, N-(2-ethylhexyl)-1,3-bis(aminomethyl)benzene, 2,2-dimethylpropane-1,3-diamine, pentane-1,3-diamine (DAMP), pentane-1,5-diamine, 1,5-diamino-2-methylpentane (MPMD), 2-butyl-2-ethylpentane-1,5-diamine (C11-neodiamine), hexane-1,6-diamine, 2,5-dimethylhexane-1,6-diamine, 2,2(4),4-trimethylhexane-1,6-diamine (TMD), heptane-1,7-diamine, octane-1,8-diamine, nonane-1,9-diamine, decane-1,10-diamine, undecane-1,11-diamine, dodecane-1,12-diamine, 1,2-, 1,3- or 1,4-diaminocyclohexane, 1,3-bis(aminomethyl)cyclohexane, 1,4-bis(aminomethyl)cyclohexane, bis(4-aminocyclohexyl)methane, bis(4-amino-3-methylcyclohexyl)methane, bis(4-amino-3-ethylcyclohexyl)methane, bis(4-amino-3,5-dimethylcyclohexyl)methane, bis(4-amino-3-ethyl-5-methylcyclohexyl)methane, 1-amino-3-aminomethyl-3,5,5-trimethylcyclohexane (IPDA), 2(4)-methyl-1,3-diaminocyclohexane, 2,5(2,6)-bis(aminomethyl)bicyclo[2.2.1]heptane (NBDA), 3(4),8(9)-bis(aminomethyl)tricyclo[5.2.1.0^{2.6}]decane, 1,4-diamino-2,2,6-trimethylcyclohexane (TMCDA), menthane-1,8-diamine, 3,9-bis(3-aminopropyl)-2,4,8,10-tetraoxaspiro[5.5]undecane, 1,3-bis(aminomethyl)benzene (MXDA), 1,4-bis(aminomethyl)benzene, bis(2-aminoethyl) ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine or higher oligomers of these diamines, bis(3-aminopropyl)polytetrahydrofurans or other polytetrahydrofurandiamines, polyoxyalkylenediamines or -triamines, especially polyoxypropylenediamines or polyoxypropylenetriamines such as, in particular, Jeffamine® D-230, Jeffamine® D-400 or Jeffamine® T-403 (all from Huntsman), polyalkyleneamines such as diethylenetriamine (DETA), triethylenetetramine (TETA), tetraethylenepentamine (TEPA), pentaethylenehexamine (PEHA), dipropylenetriamine (DPTA), N-(2-aminoethyl)propane-1,3-diamine (N3-amine), N,N′-bis(3-aminopropyl)ethylenediamine (N4-amine), N,N′-bis(3-aminopropyl)-1,4-diaminobutane, N5-(3-aminopropyl)-2-methylpentane-1,5-diamine, N3-(3-aminopentyl)pentane-1,3-diamine, N5-(3-amino-1-ethylpropyl)-2-methylpentane-1,5-diamine, N,N′-bis(3-amino-1-ethylpropyl)-2-methylpentane-1,5-diamine, 3-(2-aminoethyl)aminopropylamine, bis(hexamethylene)triamine (BHMT), N-benzylated polyalkyleneamines having one or two benzyl groups, especially benzylated DETA, TETA, N3 amine, N4 amine or DPTA, N-Aminoethylpiperazin, 3-(3-(dimethylamino)propylamino)propylamine (DMAPAPA), amine-functional adducts of the amines mentioned with epoxides, or mixtures of two or more of these amines.

The curing agent preferably comprises at least one further amine A1 selected from the group consisting of N-benzylethane-1,2-diamine, MPMD, 1,2-diaminocyclohexane, 1,3-bis(aminomethyl)cyclohexane, 1,4-bis(aminomethyl)cyclohexane, bis(4-aminocyclohexyl)methane, IPDA, 2(4)-methyl-1,3-diaminocyclohexane, MXDA, DETA, TETA, TEPA, N3-amine, N4-amine, DPTA, BHMT, polyoxypropylene diamines having an average molecular weight Mₙ in the range from 200 to 500 g/mol, and polyoxypropylene triamines having an average molecular weight Mₙ in the range from 300 to 500 g/mol.

Among these, preference is given to N-benzylethane-1,2-diamine, MXDA, 1,3-bis(aminomethyl)cyclohexane, 1,4-bis(aminomethyl)cyclohexane or bis(4-aminocyclohexyl)methane. These permit particularly rapid curing.

Preference among these is also given to IPDA. This enables an inexpensive curing agent with high glass transition temperature.

The curing agent may especially also comprise more than one further amine A1.

Suitable accelerators are especially acids or compounds hydrolyzable to acids, especially organic carboxylic acids such as acetic acid, benzoic acid, salicylic acid, 2-nitrobenzoic acid, lactic acid, organic sulfonic acids such as methanesulfonic acid, p-toluenesulfonic acid or 4-dodecylbenzenesulfonic acid, sulfonic esters, other organic or inorganic acids, such as phosphoric acid in particular, or mixtures of the abovementioned acids and acid esters; nitrates such as calcium nitrate in particular; tertiary amines such as, in particular, 1,4-diazabicyclo[2.2.2]octane, benzyldimethylamine, α-methylbenzyldimethylamine, triethanolamine, dimethylaminopropylamine, imidazoles such as, in particular, N-methylimidazole, N-vinylimidazole or 1,2-dimethylimidazole, salts of such tertiary amines, quaternary ammonium salts, such as benzyltrimethylammonium chloride in particular, amidines, such as 1,8-diazabicyclo[5.4.0]undec-7-ene in particular, guanidines, such as 1,1,3,3-tetramethylguanidine in particular, phenols, especially bisphenols, phenolic resins or Mannich bases such as, in particular, 2-(dimethylaminomethyl)phenol, 2,4,6-tris(dimethylaminomethyl)phenol or polymers produced from phenol, formaldehyde and N,N-dimethylpropane-1,3-diamine, phosphites such as, in particular, di- or triphenyl phosphites, or compounds having mercapto groups.

Preference is given to acids, nitrates, tertiary amines or Mannich bases, especially salicylic acid, calcium nitrate or 2,4,6-tris(dimethylaminomethyl)phenol, or a combination of these accelerators.

Suitable thinners are especially n-propanol, isopropanol, n-butanol, isobutanol, tert-butanol, 1-pentanol, 2-pentanol, 3-pentanol, 2-methyl-1-butanol, 3-methyl-1-butanol, 3-methyl-2-butanol, n-hexanol, 2-ethylhexanol, xylene, 2-methoxyethanol, dimethoxyethanol, 2-ethoxyethanol, 2-propoxyethanol, 2-isopropoxyethanol, 2-butoxyethanol, 2-phenoxyethanol, 2-benzyloxyethanol, benzyl alcohol, ethylene glycol, ethylene glycol dimethyl ether, ethylene glycol diethyl ether, ethylene glycol dibutyl ether, ethylene glycol diphenyl ether, diethylene glycol, diethylene glycol monomethyl ether, diethylene glycol monoethyl ether, diethylene glycol mono-n-butyl ether, diethylene glycol dimethyl ether, diethylene glycol diethyl ether, diethylene glycol di-n-butyl ether, propylene glycol butyl ether, propylene glycol phenyl ether, dipropylene glycol, dipropylene glycol monomethyl ether, dipropylene glycol dimethyl ether, dipropylene glycol di-n-butyl ether, 2,2,4-trimethylpentane-1,3-diol monoisobutyrate, diphenylmethane, diisopropylnaphthalene, mineral oil fractions, for example Solvesso® grades (from Exxon), alkylphenols such as tert-butylphenol, nonylphenol, dodecylphenol, cardanol, styrenated phenol, bisphenols, aromatic hydrocarbon resins, especially types containing phenol groups, alkoxylated phenol, especially ethoxylated or propoxylated phenol, especially 2-phenoxyethanol, adipates, sebacates, phthalates, benzoates, organic phosphoric or sulfonic esters or sulfonamides.

Preference among these is given to thinners having a boiling point of more than 200° C., especially benzyl alcohol, styrenated phenol, ethoxylated phenol, aromatic hydrocarbon resins containing phenol groups, such as, in particular, the Novares® grades LS 500, LX 200, LA 300 or LA 700 (from Rütgers), diisopropylnaphthalene or cardanol, especially benzyl alcohol.

Thinners containing phenol groups are effective also as accelerators.

Suitable stabilizers are especially stabilizers against oxidation, heat, light or UV radiation.

Suitable surface-active additives are especially defoamers, deaerating agents, wetting agents, dispersants or leveling agents.

The curing agent may comprise further constituents, especially:
further adducts, especially adducts of MPMD or ethane-1,2-diamine or propane-1,2-diamine with cresyl glycidyl ether or aromatic epoxy resins, in which unreacted MPMD, ethane-1,2-diamine or propane-1,2-diamine have been removed by distillation after the reaction;
monoamines such as, in particular, benzylamine or furfurylamine;
polyamidoamines, especially reaction products of a mono- or polybasic carboxylic acid, or the ester or anhydride thereof, especially a dimer fatty acid, with a polyamine used in stoichiometric excess, especially DETA or TETA;
Mannich bases, especially phenalkamines, i.e. reaction products of phenols, especially cardanol, with aldehydes, especially formaldehyde, and polyamines.
aromatic polyamines such as, in particular, 4,4′-, 2,4′ and/or 2,2′-diaminodiphenylmethane, 2,4(6)-toluenediamine, 3,5-dimethylthio-2,4(6)-toluenediamine or 3,5-diethyl-2,4(6)-tolylenediamine; or
compounds having mercapto groups, especially liquid mercaptan-terminated polysulfide polymers, mercaptan-terminated polyoxyalkylene ethers, mercaptan-terminated polyoxyalkylene derivatives, polyesters of thiocarboxylic acids, 2,4,6-trimercapto-1,3,5-triazine, triethylene glycol dimercaptan or ethanedithiol.

The invention further provides an epoxy resin composition comprising
a resin component comprising at least one epoxy resin and
a curing agent component comprising at least one amine of the formula (I) and/or an amine-functional adduct formed from the reaction of the amine of the formula (I) and at least one epoxy resin or monoepoxide.

A suitable epoxy resin is obtained in a known manner especially from the reaction of epichlorohydrin with polyols, polyphenols or amines.

Suitable epoxy resins are especially aromatic epoxy resins, especially the glycidyl ethers of:
bisphenol A, bisphenol F or bisphenol A/F, where A stands for acetone and F for formaldehyde used as reactants in the production of these bisphenols. In the case of bisphenol F, positional isomers may also be present, more particularly ones derived from 2,4′- or 2,2′-hydroxyphenylmethane.
dihydroxybenzene derivatives such as resorcinol, hydroquinone or catechol;
further bisphenols or polyphenols such as bis(4-hydroxy-3-methylphenyl)methane, 2,2-bis(4-hydroxy-3-methylphenyl)propane (bisphenol C), bis(3,5-dimethyl-4-hydroxyphenyl)methane, 2,2-bis(3,5-dimethyl-4-hydroxyphenyl)propane, 2,2-bis(3,5-dibromo-4-hydroxyphenyl)propane, 2,2-bis(4-hydroxy-3-tert-butylphenyl)propane, 2,2-bis(4-hydroxyphenyl)butane (bisphenol B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis(4-hydroxyphenyl)-1-phenylethane, 1,4-bis[2-(4-hydroxyphenyl)-2-propyl]benzene (bisphenol P), 1,3-bis[2-(4-hydroxyphenyl)-2-propyl]benzene (bisphenol M), 4,4′-dihydroxydiphenyl (DOD), 4,4′-dihydroxybenzophenone, bis(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis(4-hydroxyphenyl)ethane, bis(4-hydroxyphenyl) ether or bis(4-hydroxyphenyl) sulfone;
novolaks, which are especially condensation products of phenol or cresols with formaldehyde or paraformaldehyde or acetaldehyde or crotonaldehyde or isobutyraldehyde or 2-ethylhexanal or benzaldehyde or furfural;
aromatic amines such as aniline, toluidine, 4-aminophenol, 4,4′-methylenediphenyldiamine, 4,4′-methylenediphenyldi(N-methyl)amine, 4,4′-[1,4-phenylenebis(1-methylethylidene)]bisaniline (bisaniline P) or 4,4′-[1,3-phenylenebis(1-methylethylidene)]bisaniline (bisaniline M).

Further suitable epoxy resins are aliphatic or cycloaliphatic polyepoxides, especially
glycidyl ethers of saturated or unsaturated, branched or unbranched, cyclic or open-chain di-, tri- or tetrafunctional C₂ to C₃₀ alcohols, especially ethylene glycol, propylene glycol, butylene glycol, hexanediol, octanediol, polypropylene glycols, dimethylolcyclohexane, neopentyl glycol, dibromoneopentyl glycol, castor oil, trimethylolpropane, trimethylolethane, pentaerythritol, sorbitol or glycerol, or alkoxylated glycerol or alkoxylated trimethylolpropane;
a hydrogenated bisphenol A, F or A/F liquid resin or the glycidylation products of hydrogenated bisphenol A, F or A/F;
an N-glycidyl derivative of amides or heterocyclic nitrogen bases, such as triglycidyl cyanurate or triglycidyl isocyanurate, or reaction products of epichlorohydrin with hydantoin.

The epoxy resin is preferably a liquid resin or a mixture comprising two or more liquid epoxy resins.

“Liquid epoxy resin” refers to an industrial polyepoxide having a glass transition temperature below 25° C.

The resin component optionally additionally contains proportions of solid epoxy resin.

The epoxy resin is especially a liquid resin based on a bisphenol on novolaks, especially one having an average epoxy equivalent weight in the range from 156 to 210 g/eq.

A bisphenol A diglycidyl ether and/or bisphenol F diglycidyl ether, such as those commercially available from Olin, Huntsman or Momentive, is particularly suitable. These liquid resins have low viscosity for epoxy resins and permit rapid curing and high hardnesses. They may contain proportions of solid bisphenol A resin or novolak epoxy resins.

Also particularly suitable are phenol-formaldehyde novolak glycidyl ethers, especially having an average functionality in the range from 2.3 to 4, preferably 2.5 to 3. They may contain proportions of other epoxy resins, especially bisphenol A diglycidyl ether or bisphenol F diglycidyl ether.

The resin component may comprise a reactive diluent.

Preferred reactive diluents are reactive diluents containing epoxy groups, especially butanediol diglycidyl ether, hexanediol diglycidyl ether, trimethylolpropane di- or triglycidyl ether, phenyl glycidyl ether, cresyl glycidyl ether, guaiacol glycidyl ether, 4-methoxyphenyl glycidyl ether, p-n-butylphenyl glycidyl ether, p-tert-butylphenyl glycidyl ether, 4-nonylphenyl glycidyl ether, 4-dodecylphenyl glycidyl ether, cardanol glycidyl ether, benzyl glycidyl ether, allyl glycidyl ether, butyl glycidyl ether, hexyl glycidyl ether, 2-ethylhexyl glycidyl ether, or glycidyl ethers of natural alcohols, such as, in particular, C₈ to C₁₀ or C₁₂ to C₁₄ or C₁₃ to C₁₅ alkyl glycidyl ethers.

The epoxy resin composition preferably comprises at least one further constituent selected from the group consisting of thinners, accelerators, stabilizers, surface-active additives, fillers and pigments.

Suitable fillers, accelerators, stabilizers and surface-active additives are especially those already mentioned.

Suitable fillers are, in particular, ground or precipitated calcium carbonate, which is optionally coated with fatty acid, especially stearates, baryte (heavy spar), talc, quartz powder, quartz sand, silicon carbide, iron mica, dolomite, wollastonite, kaolin, mica (potassium aluminum silicate), molecular sieves, aluminum oxide, zinc oxide, aluminum-doped zinc oxide, aluminum hydroxide, magnesium hydroxide, silica, cement, gypsum, fly ash, carbon black, graphite, groundwood, metal powders such as aluminum, copper, iron, zinc, silver or steel, PVC powder or hollow beads. Preference among these is given to calcium carbonate, baryte, quartz powder, talc, or a combination thereof.

Suitable pigments are especially titanium dioxides, iron oxides, chromium(III) oxides, anticorrosion pigments, organic pigments or carbon black, especially titanium dioxides.

The epoxy resin composition may optionally comprise further auxiliaries and additives, especially the following:
reactive diluents, especially those already mentioned, or epoxidized soybean oil or linseed oil, compounds containing acetoacetate groups, especially acetoacetylated polyols, butyrolactone, carbonates, aldehydes, isocyanates or silicones having reactive groups;
polymers, especially polyamides, polysulfides, polyvinyl formal (PVF), polyvinyl butyral (PVB), polyurethanes (PUR), polymers having carboxyl groups, polyamides, butadiene-acrylonitrile copolymers, styrene-acrylonitrile copolymers, butadiene-styrene copolymers, homo- or copolymers of unsaturated monomers, especially from the group comprising ethylene, propylene, butylene, isobutylene, isoprene, vinyl acetate or alkyl (meth)acrylates, especially chlorosulfonated polyethylenes or fluorine-containing polymers or sulfonamide-modified melamines;
fibers, especially glass fibers, carbon fibers, cellulose fibers, metal fibers, ceramic fibers or polymer fibers such as polyamide fibers or polyethylene fibers;
further solids, especially wood pellets or cellulose;
nanofillers, especially carbon nanotubes;
rheology modifiers, especially thickeners or antisettling agents;
adhesion improvers, especially organoalkoxysilanes;
flame-retardant substances, especially the aluminum hydroxide or magnesium hydroxide fillers already mentioned, antimony trioxide, antimony pentoxide, boric acid (B(OH)₃), zinc borate, zinc phosphate, melamine borate, melamine cyanurate, ammonium polyphosphate, melamine phosphate, melamine pyrophosphate, polybrominated diphenyl oxides or diphenyl ethers, phosphates such as, in particular, diphenyl cresyl phosphate, resorcinol bis(diphenyl phosphate), resorcinol diphosphate oligomer, tetraphenylresorcinol diphosphite, ethylenediamine diphosphate, bisphenol A bis(diphenyl phosphate), tris(chloroethyl) phosphate, tris(chloropropyl) phosphate, tris(dichloroisopropyl) phosphate, tris[3-bromo-2,2-bis(bromomethyl)propyl] phosphate, tetrabromobisphenol A, bis(2,3-dibromopropyl ether) of bisphenol A, brominated epoxy resins, ethylenebis(tetrabromophthalimide), ethylenebis(dibromonorbornanedicarboximide), 1,2-bis(tribromophenoxy)ethane, tris(2,3-dibromopropyl)isocyanurate, tribromophenol, hexabromocyclododecane, bis(hexachlorocyclopentadieno)cyclooctane or chloroparaffins; or
further additives, especially dispersed paraffin wax or biocides.

The epoxy resin composition preferably has only a low content of thinners. It preferably contains less than 20% by weight, more preferably less than 10% by weight, in particular less than 5% by weight, of thinner, most preferably less than 1% by weight of thinner, based on the overall epoxy resin composition.

The epoxy resin composition preferably has only a low content of water, preferably less than 5% by weight, especially less than 1% by weight, of water, based on the overall epoxy resin composition.

The resin component and the curing agent component of the epoxy resin composition are stored in separate containers. Further constituents of the epoxy resin composition may be present as a constituent of the resin component or of the curing agent component; further constituents reactive toward epoxy groups are preferably a constituent of the curing agent component. It is likewise possible for further constituents to be present as a separate, further component.

A suitable container for storage of the resin component or the curing agent component is especially a vat, a hobbock, a bag, a bucket, a can, a cartridge or a tube. The components are storable, meaning that they can be stored prior to use for several months up to one year or longer without any change in their respective properties to a degree relevant to their use.

The resin component and curing agent component are mixed shortly before or during application. The mixing ratio is preferably chosen such that the molar ratio of the groups reactive toward epoxy groups relative to the epoxy groups is in the range from 0.5 to 1.5, especially 0.7 to 1.2. In parts by weight, the mixing ratio between the resin component and the curing agent component is typically within a range from 1:2 to 20:1.

The components are mixed continuously or in batches by means of a suitable method, taking care to ensure that not too much time elapses between the mixing of the components and the application, and that application takes place within the pot life. Mixing and application can be effected at ambient temperature, which is typically in the range from about 5 to 40° C., preferably about 10 to 35° C. Mixing and/or application are preferably effected at elevated temperature, especially in the range from 40 to 150° C., preferably 50 to 120° C.

Upon mixing the components, the curing of the epoxy resin composition by chemical reaction commences. Primary and secondary amino groups, and any further groups present that are reactive toward epoxy groups, react with the epoxy groups, resulting in ring opening thereof. As a result primarily of these reactions, the composition polymerizes and thereby cures.

Curing typically extends over a few hours to days. The duration depends on factors including the temperature, the reactivity of the constituents, the stoichiometry thereof, and the presence/amount of accelerators.

When freshly mixed, the epoxy resin composition has low viscosity. The viscosity at 20° C. 5 minutes after the resin component and curing agent component have been mixed is preferably in the range from 0.2 to 20 mPa·s, preferably 0.3 to 10 mPa·s, especially 0.3 to 5 mPa·s, measured using a cone-plate viscometer at a shear rate of 10 s⁻¹.

The epoxy resin composition is applied to at least one substrate and/or to at least one casting mold.

Suitable substrates are especially:
glass, glass ceramic, concrete, mortar, cement screed, fiber cement, brick, tile, plaster or natural rocks such as granite or marble;
repair compounds or leveling compounds based on PCC (polymer-modified cement mortar) or ECC (epoxy resin-modified cement mortar);
metals or alloys such as aluminum, iron, steel, copper, other nonferrous metals, including surface-finished metals or alloys such as galvanized or chrome-plated metals;
asphalt or bitumen;
leather, textiles, paper, wood, wood-based materials bonded with resins, for example phenolic, melamine or epoxy resins, resin-textile composites or further polymer composites;
plastics, such as rigid and flexible PVC, polycarbonate, polystyrene, polyester, polyamide, PMMA, ABS, SAN, epoxy resins, phenolic resins, PUR, POM, TPO, PE, PP, EPM or EPDM, in each case untreated or surface-treated, for example by means of plasma, corona or flames;
fiber-reinforced plastics, such as carbon fiber-reinforced plastics (CFP), glass fiber-reinforced plastics (GFP) and sheet molding compounds (SMC);
insulation foams, especially made of EPS, XPS, PUR, PIR, rock wool, glass wool or foamed glass;
coated or painted substrates, especially painted tiles, coated concrete, powder-coated metals or alloys or painted metal sheets;
coatings, paints or varnishes, especially coated floors that have been overcoated with a further floor covering layer.

The substrates can if required be pretreated prior to application, especially by physical and/or chemical cleaning methods or the application of an activator or a primer.

The substrates are especially coated and/or adhesively bonded.

A suitable casting mold is an apparatus into which the mixed, liquid epoxy resin composition is poured and in which it is cured, and from which it can be demolded/removed after curing, where the cured composition forms a shaped body.

The casting mold preferably consists at least of a material on the surface, from which the cured epoxy resin composition can be parted again without damage, especially made of metal, ceramic, plastic or silicone, optionally provided with a nonstick coating, especially of Teflon, silicone or a wax.

The invention further provides a cured composition obtained from the epoxy resin composition described after mixing of the resin component and the curing agent component.

The epoxy resin composition is preferably used as coating, primer, adhesive, sealant, potting compound, casting resin, impregnating resin, or as shaped body or matrix for composite materials such as, in particular, CFRP (containing carbon fibers) or GFRP (containing glass fibers) or wood composites.

The invention further provides a process for producing a shaped body, comprising the steps of
(i) mixing the components of the epoxy resin composition,
(ii) adding the mixed composition to a casting mold,
followed by the curing of the mixed composition, optionally under pressure and optionally by means of supplied heat.

The epoxy resin composition, before being cured, may be admixed with fibers, powders or pellets, especially with carbon fibers, glass fibers or wood powder and/or pellets, in order to obtain a composite material.

The shaped body may be produced in one shot in the casting mold, or it may be built up in layers, for example in order to produce a transparent shaped body usable as a tabletop, for example. It is possible here to cast any desired further material between the layers, for example decorative objects such as pearls, pieces of wood or shells.

After curing, the shaped body is preferably removed from the casting mold. It can be processed further, especially by cutting, drilling, drawing, grinding or polishing.

In the production of shaped bodies, low exothermicity on curing and a high glass transition temperature of the cured material are particularly advantageous.

The invention further provides an article comprising the cured composition formed from the epoxy resin composition described.

The article is especially a shaped body, especially a composite material, in particular a lamella, a panel or a component of an industrial good.

The article is also in particular a floor coating, wall coating, component coating, pipe coating, roof coating or anticorrosion coating.

The article is also in particular an article bonded by the epoxy resin composition.

The article is preferably a shaped body.

The shaped body is preferably a composite material.

### EXAMPLES

Working examples are adduced hereinafter, which are intended to further elucidate the invention described. The invention is of course not limited to these described working examples.

“AHEW” stands for amine hydrogen equivalent weight.

“EEW” stands for epoxy equivalent weight.

“Standard climatic conditions” (“SCC”) refers to a temperature of 23±1° C. and a relative air humidity of 50±5%.

The chemicals used were unless otherwise stated from Sigma-Aldrich Chemie GmbH.

### Description of the Measurement Methods

Viscosity was measured on a thermostated Rheotec RC30 cone-plate viscometer (cone diameter 50 mm, cone angle 1°, cone tip-plate distance 0.05 mm). Low-viscosity samples having a viscosity of less than 100 mPa·s were measured at a shear rate of 100 s⁻¹, higher-viscosity samples at a rate of 10 s⁻¹.

Amine value was determined by titration (with 0.1N HClO₄ in acetic acid against crystal violet).

Gas chromatograms (GC) were measured within the temperature range of 60 to 320° C. with a heating rate of 15° C./min and a run time of 10 min at 320° C. The injector temperature was 250° C. A Zebron ZB-5 column was used (L=30 m, ID=0.25 mm, dj=0.5 μm) with a gas flow rate of 1.5 ml/min. Detection was by flame ionization (FID).

Infrared spectra (FT-IR) were measured as undiluted films on a Nicolet iS5 FT-IR instrument from Thermo Scientific equipped with a horizontal ATR measurement unit with a diamond crystal. Absorption bands are reported in wavenumbers (cm⁻¹).

¹H NMR spectra were measured on a spectrometer of the Bruker Ascend 400 type at 400.14 MHz; the chemical shifts δ are reported in ppm relative to tetramethylsilane (TMS). No distinction was made between true coupling and pseudo-coupling patterns.

### Preparation of Amines of the Formula (I)

Amine A1: 1,4-bis(α-aminoethyl)benzene

50.0 g (0.31 mol) of 1,4-diacetylbenzene was dissolved in 800 ml of ethanol at 40° C. under a nitrogen atmosphere, and 44.8 g of a hydroxylamine solution (50% by weight in water, 0.68 mol) and a solution of 52.2 g of potassium carbonate in 250 ml of water were added, which resulted in a yellow color. Subsequently, the reaction mixture was boiled at reflux for 6 hours and then left to stand at room temperature overnight, in the course of which a white precipitate formed. The precipitate was then collected by filtration, washed with water and dried under reduced pressure for 1 hour. Subsequently, the resultant white powder was dissolved in 800 ml of a mixture of isopropyl alcohol and 1,4-dioxane (1:1 by weight) and then hydrogenated at 90° C., hydrogen pressure 90 bar and a flow rate of 5 ml/min in a continuous hydrogenation apparatus with a fixed bed Raney nickel catalyst, and the hydrogenated solution was concentrated on a rotary evaporator. 49.0 g of a yellowish oil was obtained, which was then purified by distillation. At 68 to 75° C. (vapor temperature) and 0.04 mbar, 34.4 g of distillate was obtained as a clear, colorless oil with a viscosity at 20° C. for 15 mPa·s, an amine value of 680 mg KOH/g, a 1,4-bis(α-aminoethyl)benzene content determined by GC of about 96% (retention time 9.7 min) and a calculated AHEW of 41.0 g/eq.

¹H NMR (CDCl₃): 7.31 (d, 4 H, Ar—H), 4.1 (q, 2 H, Ar—CH—N), 1.51 (br s, 4 H, NH₂), 1.39 (d, 6 H, CH₃).

FT-IR: 3359, 3279, 2957, 2920, 2856, 1594, 1508, 1448, 1367, 1328, 1188, 1097, 1015, 829, 699.

Amine A2: 1,3-bis(α-aminoethyl)benzene

The amine A2 was prepared as described for amine A1, except using 1,3-diacetylbenzene in the same amount rather than 1,4-diacetylbenzene. 47.0 g of a yellowish oil was obtained, which was then purified by distillation. At 55 to 60° C. (vapor temperature) and 0.06 mbar, 29.9 g of distillate was obtained as a clear, colorless oil with a viscosity at 20° C. of 25 mPa·s, an amine value of 661 mg KOH/g, and a 1,3-bis(α-aminoethyl)benzene content determined by GC of about 95% (retention time 9.5 min) and a calculated AHEW of 41.0 g/eq.

¹H NMR (CDCl₃): 7.32 (t, 1 H, Ar—H), 7.27 (d, 2 H, Ar—H), 7.21 (s, 1 H, Ar—H), 4.1 (q, 2 H, Ar—CH—N), 1.51 (br s, 4 H, NH₂), 1.38 (d, 6 H, CH₃).

FT-IR: 3360, 3279, 2959, 2922, 2864, 1604, 1485, 1446, 1366, 1326, 1152, 1111, 1054, 857, 795, 706.

Amine A3: 1-α-aminoethyl-4-aminomethylbenzene

50.0 g (0.34 mol) of 4-acetylbenzonitrile was dissolved in 800 ml of ethanol at 40° C. under a nitrogen atmosphere, and 2.4 g of aqueous perchloric acid (70% by weight of HClO₄ in water) was added. Then 45.0 g (0.52 mol) of methyl ethyl ketoxime was added gradually to the reaction mixture with good stirring, which was boiled at reflux for 16 h, and then the volatile constituents (ethanol, methyl ethyl ketone and excess methyl ether ketoxime) were removed on a rotary evaporator. The resultant powder was washed with water, dried under reduced pressure for 1 hour, and then dissolved in 800 ml of a mixture of isopropyl alcohol and 1,4-dioxane (1:1 by weight), and hydrogenated at 80° C., hydrogen pressure 90 bar and a flow rate of 5 ml/min in a continuous hydrogenation apparatus with a fixed bed Raney nickel catalyst, and the hydrogenated solution was finally concentrated under reduced pressure. 49.0 g of a yellowish oil was obtained, which was then purified by distillation. At 75 to 80° C. (vapor temperature) and 0.06 mbar, 23.7 g of distillate was obtained as a clear, colorless oil with a viscosity at 20° C. for 56 mPa·s, an amine value of 710 mg KOH/g, and a 1-α-aminoethyl-4-aminomethylbenzene content determined by GC of about 83% (retention time 9.5 min) and about 11.5% of a by-product (retention time 11.5 min, probably N-(1-(4-(aminomethyl)phenyl)ethyl)butane-2-amine). For further use, an AHEW of 37.6 g/eq was employed.

¹H NMR (CDCl₃): 7.27 (d, 4 H, Ar—H), 4.06 (q, 1 H, Ar—CH—N), 3.80 (s, 2 H, Ar—CH₂—N), 2.90 (br s, 4 H, NH₂), 1.36 (d, 3 H, CH₃).

FT-IR: 3359, 3280, 2959, 2921, 2823, 1606, 1509, 1448, 1417, 1366, 1278, 1202, 1097, 1016, 832, 698.

Amine A4: 1-α-aminoethyl-3-aminomethylbenzene

The amine A4 was prepared as described for amine A3, except using 3-acetylbenzonitrile in the same amount rather than 4-acetylbenzonitrile. 48.0 g of a yellowish oil was obtained, which was then purified by distillation. At 60 to 65° C. and 0.06 mbar, 19.6 g of distillate was obtained as a clear, colorless oil with a viscosity at 20° C. for 73 mPa·s, an amine value of 712 mg KOH/g, and a 1-α-aminoethyl-3-aminomethylbenzene content determined by GC of about 85% (retention time 9.4 min) and about 12% of a by-product (retention time 11.3 min, probably N-(1-(3-(aminomethyl)phenyl)ethyl)butane-2-amine). For further use, an AHEW of 37.6 g/eq was employed.

¹H NMR (CDCl₃): 7.27 (t, 1 H, Ar—H), 7.26 (m, 3 H, Ar—H), 4.06 (q, 1 H, Ar—CH—N), 3.78 (s, 2 H, Ar—CH₂—N), 2.93 (br s, 4 H, NH₂), 1.34 (d, 3 H, CH₃).

FT-IR: 3360, 3280, 2960, 2921, 2863, 1605, 1589, 1485, 1444, 1368, 1327, 1286, 1155, 1109, 1049, 999, 828, 788, 704.

### Preparation of Amine-Functional Adducts

### Adduct-1:

A mixture of 24.64 g of amine A1 (0.15 mol) and 18.57 g of benzyl alcohol was heated to 80° C. Into this was stirred gradually, with good stirring, 18.70 g of Araldite® GY 250 (0.1 mol of EP groups), while keeping the temperature of the reaction mixture between 70 and 90° C. The reaction mixture was held within this temperature range for one hour and then cooled. A clear, slightly yellowish liquid having a viscosity at 20° C. of 44.2 Pa·s, an amine value of 260 mg KOH/g, and a calculated AHEW of 123.8 g/eq was obtained.

### Adduct-2:

A mixture of 22.53 g of amine A3 (0.15 mol) and 17.67 g of benzyl alcohol was heated to 80° C. To this was added gradually, with good stirring, 18.70 g of Araldite® GY 250 (0.1 mol of EP groups), while keeping the temperature of the reaction mixture between 70 and 90° C. The reaction mixture was held within this temperature range for one hour and then cooled. A clear, slightly yellowish liquid having a viscosity at 20° C. of 22.8 Pa·s, an amine value of 268 mg KOH/g, and a calculated AHEW of 117.8 g/eq was obtained.

### Adduct-3:

A mixture of 22.53 g of amine A4 (0.15 mol) and 17.67 g of benzyl alcohol was heated to 80° C. To this was added gradually, with good stirring, 18.70 g of Araldite® GY 250 (0.1 mol of EP groups), while keeping the temperature of the reaction mixture between 70 and 90° C. The reaction mixture was held within this temperature range for one hour and then cooled. A clear, slightly yellowish liquid having a viscosity at 20° C. of 31.5 Pa·s, an amine value of 255 mg KOH/g, and a calculated AHEW of 117.8 g/eq was obtained.

Further substances and abbreviations used:

| | |
|---|---|
| Araldite ^{®} GY 250: | bisphenol A diglycidyl ether, EEW 187 g/eq |
| | (from Huntsman) |
| Araldite ^{®} DY-E: | monoglycidyl ethers of C₁₂ to C₁₄ alcohols, |
| | EEW about 290 g/eq (from Huntsman) |
| MXDA: | 1,3-bis(aminomethyl)benzene, AHEW 34 g/eq (from |
| | Mitsubishi Gas Chemical) |
| IPDA: | 1-amino-3-aminomethyl-3,5,5-trimethylcyclohexane, |
| | AHEW 42.6 g/eq (Vestamin ^{®} IPD from Evonik) |
| 1,3-BAC | 1,3-bis(aminomethyl)cyclohexane, AHEW 35.5 g/eq |
| | (from Mitsubishi Gas Chemical) |
| B-EDA | N-benzylethane-1,2-diamine, prepared as described |
| | below, 150.2 g/mol, AHEW 50.1 g/eq |
| Ancamine ^{®} K54 | 2,4,6-tris(dimethylaminomethyl)phenol |
| | (from Evonik) |

N-Benzylethane-1,2-diamine (B-EDA):

An initial charge of 180.3 g (3 mol) of ethane-1,2-diamine at room temperature was mixed with a solution of 106.0 g (1 mol) of benzaldehyde in 1200 ml of isopropanol and stirred for 2 hours, then hydrogenated at 80° C., hydrogen pressure 80 bar, and a flow rate of 5 ml/min in a continuous hydrogenation apparatus with a fixed bed Pd/C catalyst, and the hydrogenated solution was concentrated on a rotary evaporator at 65° C., resulting in the removal of unreacted ethane-1,2-diamine, water, and isopropanol. The resulting reaction mixture was purified by distillation at 80° C. under reduced pressure. This gave a colorless liquid having an N-benzylethane-1,2-diamine content determined by GC of >97%.

### Preparation of Curing Agents and Epoxy Resin Compositions

### Examples 1 to 8

For each example, the resin component and curing agent components specified in table 1 were heated separately to a temperature of 60° C. These preheated components were then used to produce a portion of 20 g of epoxy resin composition in total, by mixing the components in the weight ratio given in table 1 using a centrifugal mixer (SpeedMixer™ DAC 150, FlackTek Inc.) for 15 seconds and then testing them immediately as follows:

The mixed composition was introduced into a test tube kept at 60° C. by means of a thermostatted water bath, and a temperature sensor was positioned in the middle of the mixed material. This was used to determine the time until attainment of the maximum temperature (stated in the table as time to peak exotherm) and the maximum temperature level (peak exotherm temperature) in the mixed material. The values reported in the table are averages from three measurements. The Tg value (glass transition temperature) was measured by DSC on cured samples from the middle of the test tube from the above-described determination, and these samples were additionally stored under standard climatic conditions before the measurement for 14 days. The measurement was effected with a Mettler Toledo DSC 3+700 instrument and the measurement program (1) −10° C. for 2 min, (2) −10 to 200° C. at a heating rate of 10 K/min (=1st run), (3) 200 to −10° C. at a cooling rate of −50 K/min, (4) −10° C. for 2 min, (5) −10 to 180° C. at a heating rate of 10 K/min (=2nd run).

TABLE 1
Composition (in parts by weight) and properties of examples 1 to 8

| | Example | | | | | | | |
|---|---|---|---|---|---|---|---|---|
| | | | | | 5 | 6 | 7 | 8 |
| | 1 | 2 | 3 | 4 | (Ref.) | (Ref.) | (Ref.) | (Ref.) |
| Resin comp.: | | | | | | | | |
| Araldite ® GY 250 | 187.0 | 187.0 | 187.0 | 187.0 | 187.0 | 187.0 | 187.0 | 187.0 |
| Curing | | | | | | | | |
| agent comp.: | | | | | | | | |
| Amine A1 | 41.0 | — | — | — | — | — | — | — |
| Amine A2 | — | 41.0 | — | — | — | — | — | — |
| Amine A3 | — | — | 37.6 | — | — | — | — | — |
| Amine A4 | — | — | — | 37.6 | — | — | — | — |
| MXDA | — | — | — | — | 34.0 | — | — | — |
| IPDA | — | — | — | — | — | 42.6 | — | — |
| 1,3-BAC | — | — | — | — | — | — | 35.5 | — |
| B-EDA | — | — | — | — | — | — | — | 50.1 |
| time to peak | 21 | 20 | 23 | 20 | 12 | 21 | 8 | 12 |
| exotherm [min] | | | | | | | | |
| peak exotherm | 66° C. | 65° C. | 75° C. | 74° C. | 150° C. | 74° C. | 213° C. | 201° C. |
| temperature | | | | | | | | |
| Tg 1st/2nd run [° C.] | 52/ | 65/ | 72/ | 68/ | 93/ | 76/ | 133/ | 53/ |
| | 141 | 128 | 120 | 100 | 100 | 155 | 140 | 88 |

### Examples 9 to 24

For each example, the ingredients of the resin component specified in Tables 2 to 4 were mixed in the specified amounts (in parts by weight) using a centrifugal mixer (SpeedMixer™ DAC 150, FlackTek Inc.) and stored with the exclusion of moisture.

The ingredients of the curing agent component specified in Tables 2 to 4 were likewise processed and stored.

The two components of each composition were then processed using the centrifugal mixer into a homogeneous liquid and this was tested immediately as follows:

Viscosity was measured in the described manner at a temperature of 20° C. 5 min after mixing the resin component and curing agent component.

Gel time was determined by moving a freshly mixed amount of about 3 g under standard climatic conditions with a spatula at regular intervals until the mass underwent gelation.

Shore D hardness was determined to DIN 53505 on cylindrical test specimens (diameter 20 mm, thickness 5 mm) that were stored under standard climatic conditions, with measurement of hardness 1 day (24 h) and 2 days after production. In addition, a film was applied to a glass plate in a layer thickness of 500 μm, and this was stored/cured under standard climatic conditions. König's hardness (König's pendulum hardness to DIN EN ISO 1522) was determined on this film after 1 day, 2 days, 7 days and 14 days. After 14 days, the appearance of the film was assessed. A film was described as “nice” if it had a glossy and nontacky surface with no structure. “Structure” refers to any kind of marking or pattern on the surface. A film with reduced gloss was referred to as “dull”.

As a measure of yellowing, the change in color of some examples was determined after stress in a weathering tester. For this, a further film was applied to a glass plate in a layer thickness of 500 μm and this was stored/cured under standard climatic conditions for 2 weeks and then stressed for 72 hours at a temperature of 65° C. in a model Q-Sun Xenon Xe-1 weathering tester having a Q-SUN Daylight-Q optical filter and a xenon lamp having a light intensity of 0.51 W/m² at 340 nm (Q-Sun (72h)). The difference in color ΔE of the stressed film versus the corresponding unstressed film was then determined using an NH310 colorimeter from Shenzen 3NH Technology Co. LTD equipped with silicon photoelectric diode detector, light source A, color space measurement interface CIE L*a*b*C*H*. The Tg value (glass transition temperature) was measured as described for example 1 on samples (from the test specimen for Shore D hardness) that had been cured under standard climatic conditions for 14 days.

TABLE 2
Composition and properties of examples 9 to 14.

| | | Example | | | | | |
|---|---|---|---|---|---|---|---|
| | | | | | | 13 | 14 |
| | | 9 | 10 | 11 | 12 | (Ref.) | (Ref.) |
| Resin component: | | | | | | | |
| Araldite ® GY 250 | | 167.2 | 167.2 | 167.2 | 167.2 | 167.2 | 167.2 |
| Araldite ® DY-E | | 31.8 | 31.8 | 31.8 | 31.8 | 31.8 | 31.8 |
| Curing agent | | | | | | | |
| component: | | | | | | | |
| Amine A1 | | 41.0 | — | — | — | — | — |
| Amine A2 | | — | 41.0 | — | — | — | — |
| Amine A3 | | — | — | 37.6 | — | — | — |
| Amine A4 | | — | — | — | 37.6 | — | — |
| MXDA | | — | — | — | — | 34.0 | — |
| IPDA | | — | — | — | — | — | 42.6 |
| Viscosity (10′) [Pa · s] | | 0.41 | 0.43 | 0.37 | 0.41 | 0.38 | 0.60 |
| Gel time (h:min) | | >8:00 | >8:00 | >4:30 | 4:20 | 4:10 | 3:00 |
| Shore D | (1d SCC) | 36 | 40 | 75 | 75 | 82 | n.m. ¹ |
| | (2d SCC) | 63 | 62 | 77 | 79 | 82 | n.m. ¹ |
| König h. | (1d SCC) | 18 | 13 | 21 | 18 | 21 | 87 |
| [s] | (2d SCC) | 118 | 64 | 56 | 53 | 29 | 155 |
| | (7d SCC) | 168 | 164 | 101 | 109 | 32 | 196 |
| | (14d SCC) | 178 | 174 | 105 | 133 | 42 | 205 |

| | | | | | | |
|---|---|---|---|---|---|---|
| Appearance | nice, | slight | nice | dull | Structure | dull |
| | uneven | structure | | | | |
| Q-Sun (72 h) ΔE | 1.5 | 4.8 | 6.2 | 8.8 | 10.4 | 1.4 |
| Tg 1st/2nd run [° C.] | 69/106 | 65/90 | 53/88 | 50/80 | 54/77 | 57/104 |

¹ not measurable (too brittle)

TABLE 3
Composition and properties of examples 15 to 21.

| | | Example | | | | | | |
|---|---|---|---|---|---|---|---|---|
| | | | | | | 19 | 20 | 21 |
| | | 15 | 16 | 17 | 18 | (Ref.) | (Ref.) | (Ref.) |
| Resin component: | | | | | | | | |
| Araldite ® GY 250 | | 167.2 | 167.2 | 167.2 | 167.2 | 167.2 | 167.2 | 167.2 |
| Araldite ® DY-E | | 31.8 | 31.8 | 31.8 | 31.8 | 31.8 | 31.8 | 31.8 |
| Curing agent | | | | | | | | |
| component: | | | | | | | | |
| Amine A1 | | 20.5 | — | — | — | — | — | — |
| Amine A2 | | — | 20.5 | — | — | — | — | — |
| Amine A3 | | — | — | 18.8 | — | — | — | — |
| Amine A4 | | — | — | — | 18.8 | — | — | — |
| MXDA | | — | — | — | — | 17.0 | 34.0 | — |
| IPDA | | 21.3 | 21.3 | 21.3 | 21.3 | 21.3 | — | 42.6 |
| Benzyl alcohol | | 25.0 | 25.0 | 25.0 | 25.0 | 25.0 | 25.0 | 25.0 |
| Salicylic acid | | 2.0 | 2.0 | 2.0 | 2.0 | 2.0 | 2.0 | 2.0 |
| Ancamine ® K54 | | 2.0 | 2.0 | 2.0 | 2.0 | 2.0 | 2.0 | 2.0 |
| Viscosity (10′) [Pa · s] | | 0.62 | 0.61 | 0.58 | 0.58 | 0.39 | 0.37 | 0.62 |
| Gel time (h:min) | | 4:15 | 4:35 | 4:15 | 4:15 | 2:40 | 3:00 | 3:00 |
| Shore D | (1d SCC) | 66 | 52 | 71 | 62 | 77 | 78 | 77 |
| | (2d SCC) | 78 | 72 | 78 | 75 | 78 | 79 | 79 |
| König h. | (1d SCC) | 42 | 18 | 52 | 39 | 59 | 36 | 91 |
| [s] | (2d SCC) | 118 | 85 | 111 | 95 | 106 | 42 | 143 |
| | (7d SCC) | 160 | 143 | 158 | 155 | 145 | 60 | 155 |
| | (14d SCC) | 164 | 158 | 161 | 157 | 150 | 74 | 158 |

| | | | | | | | |
|---|---|---|---|---|---|---|---|
| Appearance | nice | nice | nice | nice | nice | Structure | nice |
| Tg 1st/2nd run [° C.] | 47/97 | 47/92 | 46/88 | 48/84 | 44/59 | 46/76 | 57/99 |

TABLE 4
Composition and properties of examples 22 to 24.

| Example | 22 | 23 | 24 |
|---|---|---|---|
| Resin component: | | | |
| Araldite ^{®} GY 250 | 167.2 | 167.2 | 167.2 |
| Araldite ^{®} DY-E | 31.8 | 31.8 | 31.8 |
| Curing agent | | | |
| component: | | | |
| Adduct-1 | 24.8 | — | — |
| Adduct-2 | — | 23.6 | — |
| Adduct-3 | — | — | 23.6 |
| B-EDA | 20.0 | 20.0 | 20.0 |
| IPDA | 17.0 | 17.0 | 17.0 |
| Benzyl alcohol | 17.6 | 17.9 | 17.9 |
| Ancamine ^{®} K54 | 2.0 | 2.0 | 2.0 |
| Viscosity (10′) [Pa • s] | 0.56 | 0.55 | 0.58 |
| Gel time (h:min) | >3:30 | >3:30 | >3:30 |
| Shore D (1 d SCC) | 62 | 62 | 65 |
| (2 d SCC) | 77 | 76 | 77 |
| König h. (1 d SCC) | 36 | 32 | 38 |
| [s] (2 d SCC) | 84 | 70 | 71 |
| (7 d SCC) | 153 | 145 | 144 |
| (14 d SCC) | 164 | 168 | 167 |
| Appearance | nice | nice | nice |
| Tg 1st/2nd run [° C.] | 50/79 | 51/79 | 49/77 |

1. The use of an amine of the formula (I) for curing of epoxy resins: 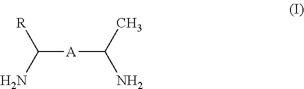
where
R is H or methyl, and
A is a phenylene or cyclohexylene radical.

2. The use as claimed in claim 1, characterized in that A is selected from the group consisting of 1,3-phenylene, 1,4-phenylene, 1,3-cyclohexylene and 1,4-cyclohexylene.

3. The use as claimed in claim 1, characterized in that the amine of the formula (I) is selected from the group consisting of 1,4-bis(α-aminoethyl)benzene, 1,3-bis(α-aminoethyl)benzene, 1-α-aminoethyl-4-aminomethylbenzene and 1-α-aminoethyl-3-aminomethylbenzene.

4. The use as claimed in claim 1, characterized in that the amine of the formula (I) is 1,4-bis(α-aminoethyl)benzene or 1,3-bis(α-aminoethyl)benzene.

5. The use as claimed in claim 1, characterized in that the amine of the formula (I) is a constituent of a reaction product obtained from the reaction of
at least one ketone of the formula (II) with
ammonia or hydroxylamine or an oxime of the formula (III) and subsequent hydrogenation, 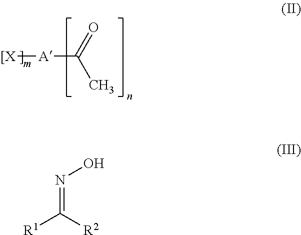
where
m is 0 or 1, n is 1 or 2 and (m+n) is 2,
X is formyl or nitrile,
A′ is a phenylene or cyclohexylene radical,
R¹ is H or methyl, and
R² is H or an alkyl radical having 1 to 4 carbon atoms.

6. An amine-functional adduct from the reaction of the amine of the formula (I) as described in claim 1 with at least one epoxy resin or monoepoxide.

7. A curing agent for epoxy resins comprising at least one amine of the formula (I) as described in claim 1 and/or at least one adduct from the reaction of the amine of formula (I) with at least one epoxy resin or monoepoxide, and at least one further constituent selected from further amines A1, accelerators, thinners, stabilizers and surface-active additives.

8. An epoxy resin composition comprising
a resin component comprising at least one epoxy resin and
a hardener component containing at least one amine of the formula (I) as described in claim 1 and/or an amine-functional adduct from the reaction of the amine of formula (I) with at least one epoxy resin or monoepoxide or a hardener comprising the at least one amine and/or the amine-functional adduct and at least one further constituent selected from further amines A1, accelerators, thinners, stabilizers and surface-active additives.

9. A cured composition obtained from the epoxy resin composition as claimed in claim 8 after the resin component and the curing agent component have been mixed.

10. A process for producing a shaped body, comprising the steps of
(i) mixing the components of the epoxy resin composition as claimed in claim 8,
(ii) adding the mixed composition to a casting mold,
followed by the curing of the mixed composition, optionally under pressure and optionally by means of supplied heat.

11. An article comprising the cured composition as claimed in claim 9.

12. The article as claimed in claim 11, wherein it is a shaped body.

13. The article as claimed in claim 12, wherein the shaped body is a composite material.

14. A reaction product containing at least one amine of the formula (I) obtained from the reaction of
at least one ketone of the formula (II) with
ammonia or hydroxylamine or an oxime of the formula (III) and subsequent hydrogenation, 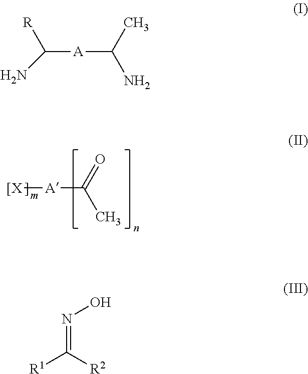
where
R is H or methyl,
A is a phenylene or cyclohexylene radical,
m is 0 or 1, n is 1 or 2 and (m+n) is 2,
X is formyl or nitrile,
A′ is a phenylene or cyclohexylene radical,
R¹ is H or methyl, and
R² is H or an alkyl radical having 1 to 4 carbon atoms.

15. The reaction product as claimed in claim 14, wherein the ketone of the formula (II) is 1,3-diacetylbenzene or 1,4-diacetylbenzene.
